(19) United States
(12) Patent Application Publication
(10) Pub. No.: US 2013/0128090 A1
(43) Pub. Date: May 23, 2013

(54) IMAGE PHOTOGRAPHING DEVICE AND IMAGE PHOTOGRAPHING METHOD THEREOF

(71) Applicant: Song-ha CHOI, Anyang-si (KR)

(72) Inventor: Song-ha CHOI, Anyang-si (KR)

(73) Assignee: Samsung Electronics Co., Ltd, Suwon-si (KR)

(21) Appl. No.: 13/617,926

(22) Filed: Sep. 14, 2012

(30) Foreign Application Priority Data
Nov. 22, 2011 (KR) 10-2011-0122496

(51) Int. Cl. H04N 5/225

(52) U.S. Cl. 348/333.02; 348/E05.024

(57) ABSTRACT

An image photographing device and an image photographing method thereof. The image photographing method designates a subject area on a display screen of the image photographing device, displays a guide image on a designated subject area on a live view, while displaying the live view on the display screen, and obtains a subject image from which the guide image is excluded. By the above, a user requesting a photographing by another may easily let the requested person know a background composition and a location and size of the subject to be photographed.

### CROSS-REFERENCE TO RELATED APPLICATIONS

This application claims priority from Korean Patent Application No. 2011-0122496, filed in the Korean Intellectual Property Office on Nov. 22, 2011, the disclosure of which is incorporated herein by reference.

### BACKGROUND OF THE INVENTION

1. Field of the Invention

Methods and apparatuses consistent with the exemplary embodiments relate to an image photographing method and image photographing device thereof, and more particularly to an image photographing device which photographs an image by providing a UI to guide photographing to a live view, and an image photographing method thereof.

2. Description of the Related Art

In cases where a user of a camera would like to take a photograph of themself, the user must ask someone else to take the photograph for this purpose. In this case, it is possible to alternatively use a tripod or timer photographing method, but carrying a tripod is inconvenient and sometimes the current location may not be suitable to place a tripod and camera combination. For example, the location may be too small, or the surface in which the tripod would be placed may be too rugged for stability of the tripod and camera combination.

Meanwhile, in cases where the user asks someone else to take a photograph of himself/herself, not only is it difficult to deliver such a message by word, but the user's intentions may not be understood exactly by the other person being asked. Furthermore, when a user wants another photograph to be taken (a second photograph), he/she may find it inconvenient to them or the other person to ask the other person for more time to take another photograph, since the other person would be taking the photograph out of courtesy.

Therefore, when asking another person to take a photograph of himself/herself, it is necessary to explain the exact position of the subject (for example, the person who is asking) to the other person.

In order to resolve such problems, there are conventional ways to provide guidelines or background images to a live view. However, such methods also required telling the other person where the subject should be placed.

### SUMMARY OF THE INVENTION

The present exemplary embodiments relate to an image photographing device which provides a guide image to tell exactly where to place a subject, and an image photographing method thereof.

Additional features and utilities of the present general inventive concept will be set forth in part in the description which follows and, in part, will be obvious from the description, or may be learned by practice of the general inventive concept.

According to an exemplary embodiment of the present disclosure, an image photographing method may include designating a subject area on a display screen of an image photographing device; displaying a guide image on the designated subject area on a live view, while displaying the live view on the display screen; and obtaining a subject image from which the guide image has been excluded, when a photographing has been performed.

The image photographing method may further include photographing a background image according to a user operation; and extracting a silhouette of the background image, and the designating may designate the subject area on the silhouette of the extracted background image, and the displaying may display the silhouette of the extracted background image on the live view, together.

The designating may designate a location of the subject area or a size and location of the subject area together according to the user operation.

The image photographing method may further include displaying a guide message telling to place the subject in the subject area, when the guide image is displayed on the display screen.

The image photographing method may further include changing a setting of photographing an image based on the subject area, when the subject is placed in the guide image, and a half-shutter operation is input.

The changing the setting of photographing an image may change a focus of the photographing image to a center of the subject area.

A guideline for designating the subject area may be displayed on the display screen.

The image photographing method may further include calculating a subject composition score using the guideline and the size and location of the designated subject area, when the subject area is designated; and displaying the calculated composition score.

The guide image may have a shape of a human's face.

The image photographing may further include automatically photographing the image of the live view, when the size and location of the subject are identical to the size and location of the subject area.

According to an exemplary embodiment of the present disclosure, an image photographing device may include a photographing unit which photographs an image; a user input unit which receives a user operation; a display unit; and a control unit which designates a subject area on a screen displayed on the display unit using the user input unit, displays a guide image on the designated subject area on a live view while displaying the live view on the display unit, and when a photographing is performed by the photographing unit, may obtain a subject image from which the guide image has been excluded.

The control unit may photograph a background image using the photographing unit, extract a silhouette of the background image, designate the subject area on a silhouette of the extracted background image, and display the silhouette of the extracted background image on the live view.

The control unit may designate a location of the subject area or the location and a size of the subject area, together, according to the user operation input through the user input unit.

The control unit may display a guide message telling to place the subject in the subject area, when the guide image is displayed on the display screen.

The control unit may change a setting of photographing an image based on the subject area, when the subject is placed in the guide image and a half-shutter operation is input.

The changing the setting of photographing an image may change a focus of the photographing image to a center of the subject area.

The control unit may display a guideline for designating the subject area on a screen displayed on the display unit.

The control unit may calculate a subject composition score using the guideline and the size and location of the designated subject area, and display the calculated composition score on the display unit, when the subject area is designated.

The guide image may have a shape of a human's face.

The control unit may automatically photograph the image of the live view, when the size and location of the subject are identical to the size and location of the subject area.

According to an exemplary embodiment of the present disclosure, an image photographing method comprise: determining a location to place a subject image on a display screen of an image photographing device; displaying a guide image at the determined location together with a live view on the display screen; and photographing the subject image at the location of the guide image to obtain a photograph of the subject image at the determined location together with a background image.

In an exemplary embodiment, the determining a location to place a subject image further includes: photographing a background image according to a user operation; and extracting a silhouette of the background image in which the subject image is to be placed.

According to an exemplary embodiment of the present disclosure, an image photographing device comprise: a photographing unit to photograph an image; a user input unit to receive a user operation; a display unit; and a control unit to designate a subject area on a display of the display unit using the user input unit, to display a guide image on the designated subject area on a live view while displaying the live view on the display unit, and to obtain a subject image on the live view where the guide image was displayed when a photograph is taken.

In an embodiment, the control unit photographs a background image using the photographing unit, extracts a silhouette of the background image, designates the subject area on a silhouette of the extracted background image, and displays the silhouette of the extracted background image on the live view.

According to an exemplary embodiment of the present disclosure, a non-transient computer readable recording medium stores codes to perform a method of photographing an image, the method comprising: determining a location to place a subject image on a display screen of an image photographing device; displaying a guide image at the determined location together with a live view on the display screen; and photographing the subject image at the location of the guide image to obtain a photograph of the subject image at the determined location together with a background image.

### BRIEF DESCRIPTION OF THE DRAWINGS

The above and/or other features and utilities of the present general inventive concept will be more apparent by describing certain present disclosure with reference to the accompanying drawings, in which:

FIG. 1 is a block diagram illustrating a configuration of an image photographing device according to an exemplary embodiment of the present disclosure;

FIGS. 2 to 9 are views explaining a method of photographing an image using a guide image according to various exemplary embodiments of the present disclosure; and

FIG. 10 is a flowchart explaining an image photographing method according to an exemplary embodiment of the present disclosure.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

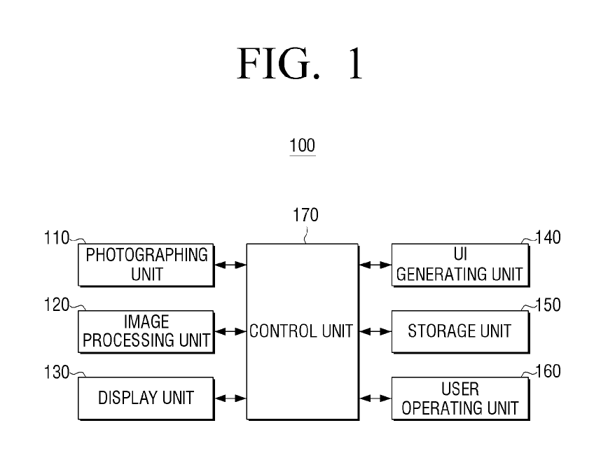

FIG. 1 is a block diagram illustrating a configuration of an image photographing device according to an exemplary embodiment of the present disclosure. As illustrated in FIG. 1, an image photographing device 100 includes a photographing unit 110, image processing unit 120, display unit 130, UI generating unit 140, storage unit 150, user input unit 160, and control unit 170. Herein, the image photographing device 100 according to an exemplary embodiment of the present disclosure may be a digital camera, but the present disclosure is not limited to a digital camera, and can be embodied as a mobile phone, PDA, tablet PC, and camcorder which has a photographing unit.

The photographing unit 110 includes a shutter, lens unit, aperture, and a CCD (Charge Coupled Device) image sensor and an ADC (Analog/Digital Converter). The shutter is a device which adjusts a volume of exposed light, together with the aperture. The lens unit receives light from an outer light source and processes an image. Herein, the aperture adjusts a volume of incident light (light volume) according to its opened degree. The CCD image sensor accumulates light volume entering through the lens unit, and outputs an image photographed in the lens unit as vertical synchronizing signals according to the accumulated light volume. Obtaining of an image by the image photographing device 100 is made by the CCD image sensor which converts light reflected from a subject into electrical signals. In order to obtain a color image using the CCD image sensor, a color filter is required, and a CFA (Color filter array) is the most generally used color filter. A CFA only penetrates light which represents one color per each pixel, has a consistent sequence structure, and has various forms depending on sequence structures. An ADC converts analogue image signals output from the CCD image sensor into digital signals.

Meanwhile, the image photographing by the photographing unit 110 as aforementioned is merely an exemplary embodiment, and thus images can be photographed by other methods as well. For example, a CMOS (Complementary Metal Oxide Semiconductor) image sensor may also be used to photograph an image instead of a CCD image sensor.

The image processing unit 120 signal processes RAW data which has been digitally converted by a control of the control unit 170 so that it may be displayed. The image processing unit 120 removes a black level by a dark current which is generated in the CCD image sensor and CFA filter which are sensitive to temperature. The image processing unit 120 performs a gamma correction which encodes information in accordance with a nonlinearity of human vision. The image processing unit 120 performs a CFA interpolation which interpolates a Bayer pattern embodied as an RGRG line and GBGB line of the gamma corrected data into an RGB line. The image processing unit 120 converts the RGB signal into a YUV signal, performs an edge filter process of clearly processing an image by filtering of a Y signal by a high bandwidth, and a color correction process of correcting a color value of U and V signals using a standard color coordinate system, and removes noise in these signals. The image processing unit 120 compresses and signal processes the Y, U, V signals from which noise has been removed, generates a JPEG file, and then the generated JPEG file is displayed on the display unit 130 and stored in the storage unit 150.

Meanwhile, such an image processing by the image processing unit 120 is merely an exemplary embodiment of the present disclosure, and there are also other ways to process images.

The display unit 130 displays image data processed in the image processing unit 120 or stored in the storage unit 150. In addition, the display unit 130 displays a UI generated by the UI generating unit 140. Especially, the display unit 130 may display a guide image which guides a location and size of the subject, by a control of the control unit 170.

The UI generating unit 140 generates the UI in an OSD (On Screen Display) form by the control of the control unit 170. Herein, the UI generating unit 140 may generate a guide image which guides the location and size of the subject and a guide message which tells to place the subject in a subject area.

The storage unit 150 stores a program and data to drive the image photographing device 100, and stores the image data processed in the image processing unit 120.

The user input unit 160 receives an operation by a user. Herein, the user input unit 160 may be embodied as a shutter, a button and a touch screen provided outside the image photographing device 100.

The control unit 170 controls overall operations of the image photographing device 100 according to a user command input through the user input unit 160. Especially, the control unit 170 designates the subject area on a screen displayed on a display unit according to the user input from the user input unit 160. In addition, the control unit 170 displays the guide image on the designated subject area on a live view while displaying the live view on the display screen. Herein, the guide image is an image which guides the location and size of the subject which the user intends to photograph. In addition, when a photographing is performed by the photographing unit 110, the control unit 170 obtains a subject image from which the guide image is excluded. In other words, once the photograph is taken, the photographed subject image replaces the guide image such that the subject image is placed at the designated subject area.

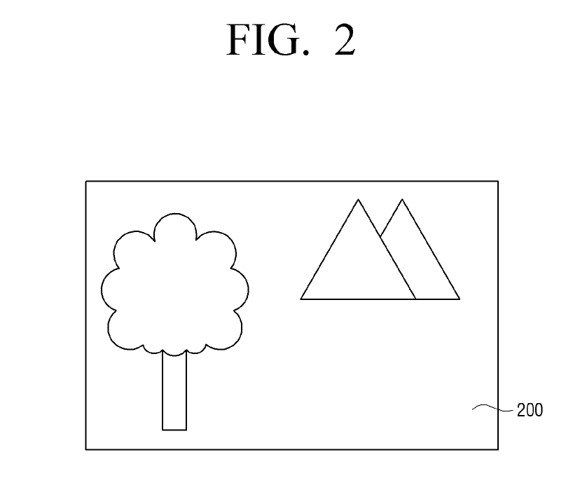

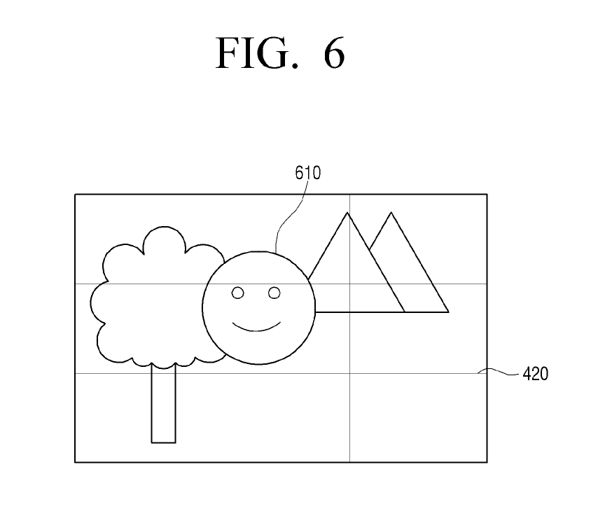

Hereinbelow is a detailed explanation of a method of photographing an image using the guide image with reference to FIGS. 2 to 9.

According to a user operation, the control unit 170 enters into a mode to designate the subject area. In addition, the control unit 170 designates a background image and subject area where the subject is to be placed.

More specifically, as illustrated in FIG. 2, the control unit 170 photographs a background image 200 through the photographing unit 110. Herein, the background image is an image which includes the background that the user intends to photograph.

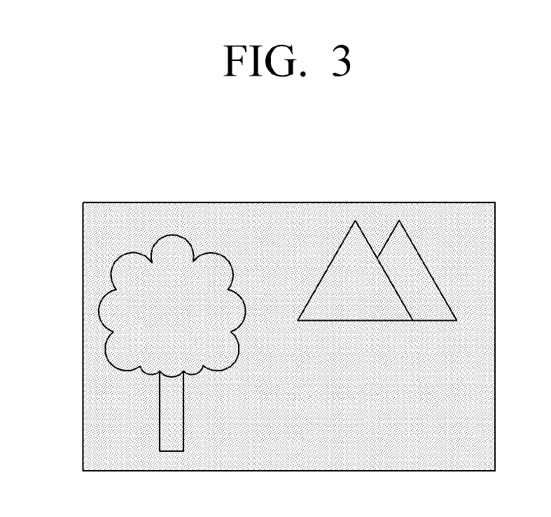

When the background image 200 is photographed, the control unit 170 stores the background image 200 in the storage unit 150, and extracts a silhouette of the background image 200 to be displayed on the live view. More specifically, the control unit 170 thresholds an edge area, dividing it into an edge area and the remaining area. In addition, the control unit 170 transparent-mask-processes the other area, and extracts the edge area as illustrated in FIG. 3. The skill of thresholding the edge area is a well known skill, and thus a detailed explanation has been omitted.

Meanwhile, the aforementioned step of designating the background image may be omitted depending on the user's needs.

The control unit 170 designates the subject area on the display screen according to the user operation input through the user input unit 160. Herein, the subject area refers to the area where the subject that the user wants to photograph (i.e., himself/herself) should be placed.

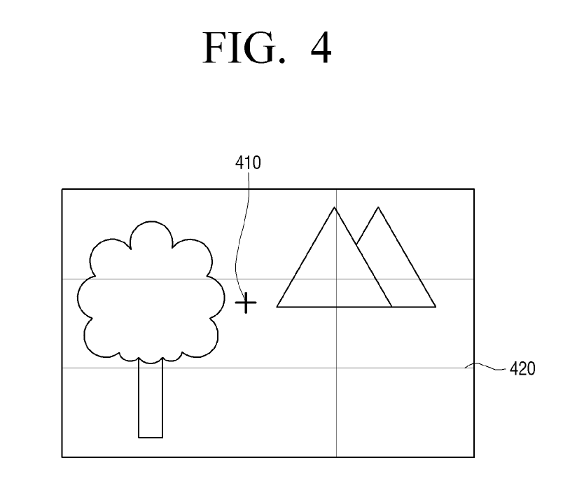

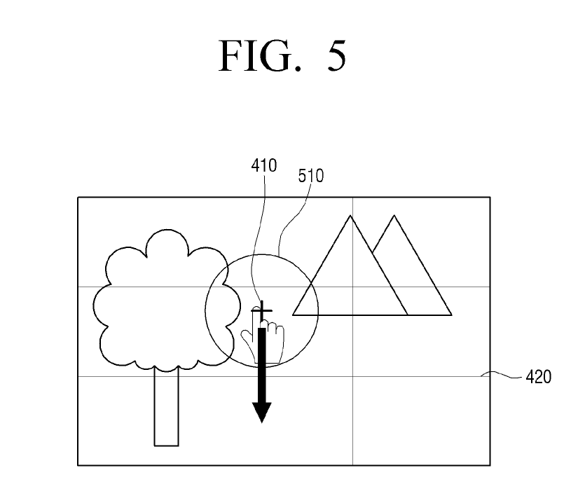

For example, when a first point is touched through a touch screen, the control unit 170 displays a cross icon 410 which represents the location of the subject area on the first point, as illustrated in FIG. 4. In addition, when a touch is moved from the first point to a downward direction, the control unit 170 displays the guide image 10 as illustrated in FIG. 5. Herein, the control unit 170 may change the size of the guide image 510 according to a state of the moved touch and designate the size of the subject area. For example, if the touch is moved in a downward direction, the control unit 170 may gradually increase the guide image 510. If the touch is moved in an upward direction, the control unit 170 may gradually decrease the guide image 510.

Meanwhile, designating the location and size of the guide image 510 using the touch screen is merely an exemplary embodiment, and thus it is possible to designate the location and size of the guide image 510 using other operating units 160 (for example, a button). In addition, the location and size of the guide image 510 may also be designated by other touch input methods.

When designating the subject area, the control unit 170 may display the photographed background image 200 on the display screen, as illustrated in FIG. 4. In addition, the control unit 170 may display a guideline 420 which divides the display screen into a plurality of areas together. This is to help the user obtain a better composition of the image by displaying the background image 200 and guideline 420 together.

Meanwhile, as illustrated in FIG. 5, the guide image 510 may be displayed as an icon shape having a cross in the center of a circle, but this is merely an exemplary embodiment, and thus the guide image 510 may be displayed as an icon 610 in a shape of, for example, a human's face (i.e., a “smiley face”).

In addition, when the subject area is designated, the control unit 170 may calculate a subject composition score using the guideline 420 displayed on the display screen and the size and location of the designated subject area. Herein, the subject composition score may be calculated depending on how close the subject area is to the location corresponding to the guideline.

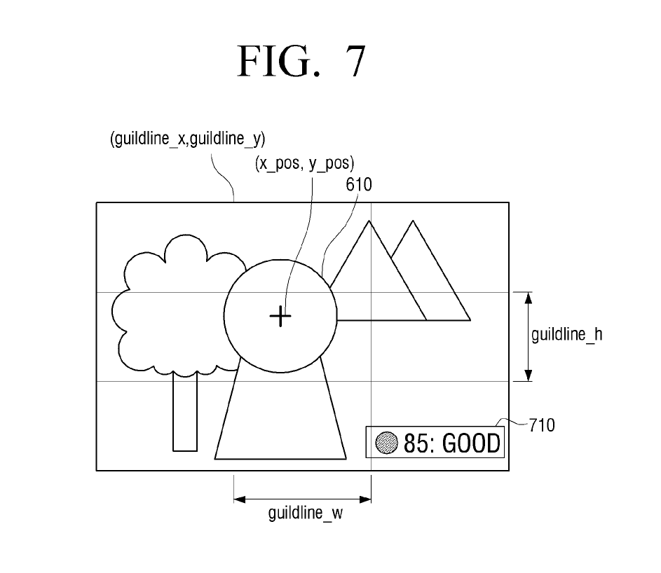

For example, as illustrated in FIG. 7, in the case where the center of the subject area is (xₚₒₛ, yₚₒₛ), the control unit 170 may calculate the composition score of the subject area using mathematical formula 1 shown below.

$$score = 100 - \frac{abs ( {x}_{pos} - {guideline}_{x} ) * 50}{{guideline}_{w}} - \frac{abs ( {y}_{pos} - {guideline}_{y} ) * 50}{{guideline}_{h}} \qquad [ Mathematical formula 1 ]$$

As can be seen from the above mathematical formula 1, the closer the location of the designated subject area is to the guideline, the smaller the abs value becomes, and thus a score close to 100 may be generated.

When a composition score of the subject area is calculated, the control unit 170 displays an icon 710 which includes the calculated composition score and composition state. Herein, the composition state may be divided into a plurality of steps in proportion to the calculated composition state. For example, the higher the composition score, the composition state may correspond to a good step among the plurality of steps, whereas the lower the composition score, the composition state may correspond to a bad step among the plurality of steps.

As the image photographing device 100 calculates and displays the composition score of the subject area, the user becomes able to determine whether or not the subject area he/she has designated is a good composition.

When a user operation is input after the subject area is designated in the method as illustrated in FIGS. 2 to 7, the control unit 170 enters into a photographing mode and displays a live view on the display unit 130.

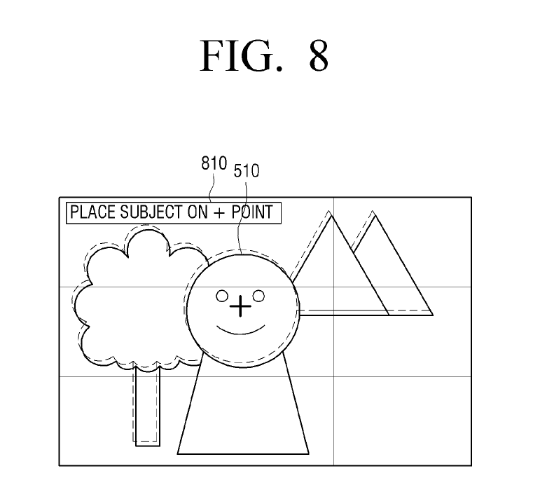

Herein, the control unit 170 displays the guide image corresponding to the subject area designated by the user on the live view, while displaying the live view on the display screen. In addition, the control unit 170 may simultaneously display the silhouette (shown in dotted line in FIG. 8) of the background image extracted from FIG. 3 on the live view.

Herein, when the guide image 510 is displayed, the control unit 170 may display a UI 810 which includes a message which instructs where to place the subject in the area where the guide image 510 is displayed (i.e., the designated area), as illustrated in FIG. 8.

In addition, when the subject area is placed in the guide image 510 and a half-shutter operation is input, the control unit 170 may change a setting of photographing the image based on the subject area. That is, the control unit 170 can perform an Auto Focusing, Automatic Exposure, Auto White Balancing and Backlight Correcting based on the subject area. For example, when the subject is placed in the guide image 510, and a half-shutter operation is input, the control unit 170 may change the focus point of the photographed image to the center of the subject area.

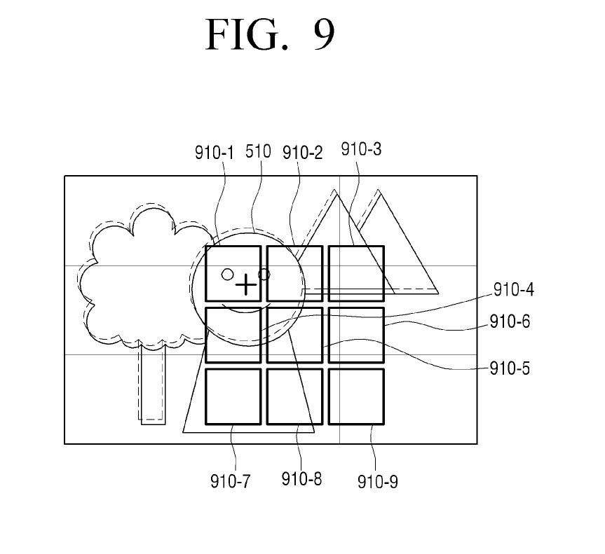

Herein, as illustrated in FIG. 9, in the case where a focus window 910-1 to 910-9 is plural, the control unit 170 may set the focus point to the center of the subject area and the closest focus window 910-1.

In addition, when the size and location of the subject are identical to the size and location of the subject area, the control unit 170 may automatically photograph the image (of the subject) of the current live view.

When a photographing is performed by the photographing unit 110, the control unit 170 obtains a subject image from which the guide image 510 and guideline are excluded. In other words, as described above, when the photograph is taken, the photographed subject image replaces the guide image and guideline such that the subject image is placed at the designated subject area.

As aforementioned, by displaying the guide image where the subject image is to be placed, the user requesting a photographing can easily inform the other person (person taking the photograph) of the background composition and location and size of the subject area.

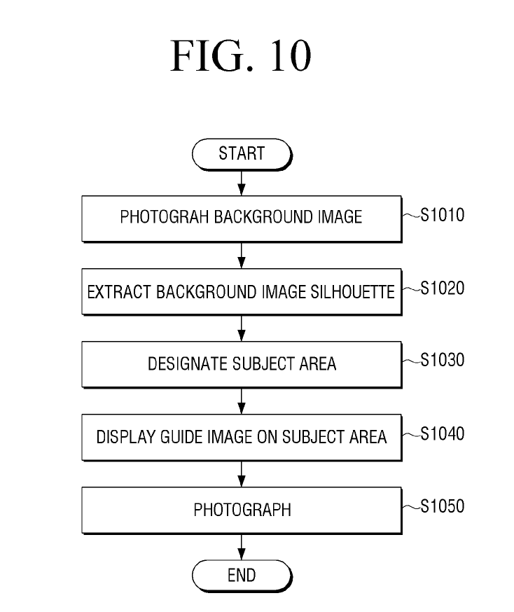

Hereinbelow is a more detailed explanation of embodiments of the present disclosure with reference to FIG. 10, which is a flow chart explaining the image photographing method of the image photographing device 100 according to an exemplary embodiment of the present disclosure.

First, the image photographing device 100 photographs the background image using the photographing unit 110 (S1010). Herein, the background image includes the background that the user intends to photograph.

When the background image is photographed, the image photographing device 100 extracts the edge area, and extracts a silhouette of the background image (S1020). More specifically, when the background image is photographed, the image photographing device 100 stores the background image in the storage unit, and extracts the silhouette of the background image 200 to be displayed on the live view. More specifically, the control unit 170 thresholds the edge area and divides it into the edge area and the remaining area. In addition, the control unit 170 transparent-mask-processes the remaining area (or background image), and extracts the edge area as illustrated in FIG. 3.

In addition, the image photographing device 100 designates the subject area according to the user operation (S1030). Herein, the image photographing device 100 may designate not only the location of the subject area but also its size. In addition, when designating the subject area, the image photographing device 100 may display the background image photographed in S1010 and the guideline on the display unit 130. In addition, the image photographing device 100 may calculate the composition score regarding the designated subject area.

In addition, the image photographing device 100 displays the guide image on the designated subject area (S1040). Herein, the guide image may be an icon including cross-hairs inside a circle or an icon in the form of a human's face.

In addition, the image photographing device 100 performs photographing using the guide image (S1050). Specifically, when the subject image is placed in the location of the guide image, and the half-shutter operation is input, the image photographing device 100 may change the setting of the photographing image based on the subject area. That is, the image photographing device 100 performs the Auto Focusing, Automatic Exposure, Auto White Balancing, and Backlight Correcting based on the subject area. For example, when the subject image is placed in the guide image and when the half-shutter operation is input, the image photographing device 100 may change the focus of the photographing image to the center of the subject area.

In addition, when photographing an image, the image photographing device 100 may display the guide image corresponding to the subject area designated by the user on the live view while displaying the live view on the display screen.

In another exemplary embodiment, when the size and location of the subject are identical to the size and location of the subject area, the image photographing device 100 may automatically photograph the image of the current live view.

By the above described method, the user requesting photographing by another person can easily let the other person know the background composition and the location and size of the subject to be photographed.

A program code to perform a photographing method according to various exemplary embodiments as aforementioned may be stored in various types of recording media, such as a RAM (Random Access Memory), Flash Memory, ROM (Read Only Memory), EPROM (Erasable Programmable ROM), EEPROM (Electronically Erasable and Programmable ROM), Register, Hard Disk, Removable Disk, Memory Card, USB Memory, and CD-ROM, which can be read by a terminal.

Although a few embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. An image photographing method, comprising:
designating a subject area on a display screen of an image photographing device;
displaying a guide image on the designated subject area on a live view, while displaying the live view on the display screen; and
obtaining a subject image from which the guide image is excluded, when a photographing is performed.

2. The image photographing method according to claim 1, further comprising:
photographing a background image according to a user operation; and
extracting a silhouette of the background image,
wherein the designating designates the subject area on the silhouette of the extracted background image and the displaying simultaneously displays the silhouette of the extracted background image on the live view.

3. The image photographing method according to claim 1, wherein the designating designates a location of the subject area or a size and location of the subject area together according to the user operation.

4. The image photographing method according to claim 1, further comprising:
displaying a guide message telling to place the subject in the subject area, when the guide image is displayed on the display screen.

5. The image photographing method according to claim 1, further comprising:
changing a setting of photographing an image based on the subject area, when the subject is placed in the guide image, and a half-shutter operation is input.

6. The image photographing method according to claim 5, wherein the changing the setting of photographing an image changes a focus of the photographing image to a center of the subject area.

7. The image photographing method according to claim 1, wherein a guideline for designating the subject area is displayed on the display screen.

8. The image photographing method according to claim 7, further comprising:
calculating a subject composition score using the guideline and the size and location of the designated subject area, when the subject area is designated; and
displaying the calculated composition score.

9. The image photographing method according to claim 1, wherein the guide image has a shape of a human's face.

10. The image photographing method according to claim 1, further comprising:
automatically photographing the image of the live view, when the size and location of the subject are identical to the size and location of the subject area.

11. An image photographing device, comprising:
a photographing unit which photographs an image;
a user input unit which receives a user operation;
a display unit; and
a control unit which designates a subject area on a screen displayed on the display unit using the user input unit, displays a guide image on the designated subject area on a live view while displaying the live view on the display unit, and when a photographing is performed by the photographing unit, obtains a subject image from which the guide image is excluded.

12. The image photographing device according to claim 11, wherein the control unit photographs a background image using the photographing unit, extracts a silhouette of the background image, designates the subject area on a silhouette of the extracted background image, and displays the silhouette of the extracted background image on the live view.

13. The image photographing device according to claim 11, wherein the control unit designates a location of the subject area or the location and a size of the subject area, together, according to the user operation input through the user input unit.

14. The image photographing device according to claim 11, wherein the control unit displays a guide message instructing to place the subject in the subject area, when the guide image is displayed on the display screen.

15. The image photographing device according to claim 11, wherein the control unit changes a setting of photographing an image based on the subject area, when the subject is placed in the guide image and a half-shutter operation is input.

16. The image photographing device according to claim 15, wherein the changing the setting of photographing an image changes a focus of the photographing image to a center of the subject area.

17. The image photographing device according to claim 11, wherein the control unit displays a guideline to designate the subject area on a screen displayed on the display unit.

18. The image photographing device according to claim 17, wherein the control unit calculates a subject composition score using the guideline and the size and location of the designated subject area, and displays the calculated composition score on the display unit, when the subject area is designated.

19. The image photographing device according to claim 11, wherein the guide image has a shape of a human's face.

20. The image photographing device according to claim 11, wherein the control unit automatically photographs the image of the live view, when the size and location of the subject are identical to the size and location of the subject area.
